(19) United States
(12) Patent Application Publication
(10) Pub. No.: US 2024/0390900 A1
(43) Pub. Date: Nov. 28, 2024

(54) MICROFLUIDIC DEVICE AND METHOD FOR FILLING A FLUID CHAMBER OF SUCH A DEVICE

(71) Applicant: MICRONIT HOLDING B.V., Enschede (NL)

(72) Inventors: Marko Theodoor BLOM, Enschede (NL); Ronny VAN 'T OEVER, Enschede (NL); Alvaro Jose CONDE, Enschede (NL)

(73) Assignee: MICRONIT HOLDING B.V., Enschede (NL)

(21) Appl. No.: 18/694,038

(22) PCT Filed: Oct. 3, 2022
(86) PCT No.: PCT/NL2022/050551

§ 371 Date: Mar. 21, 2024

(30) Foreign Application Priority Data
Oct. 4, 2021 (NL) 2029317

(51) Int. Cl. B01L 3/00

(52) U.S. Cl. CPC B01L 3/502738; B01L 3/502746; B01L 2200/0684; B01L 2300/042; B01L 2400/0688

(57) ABSTRACT

A microfluidic device includes a microfluidic circuit having a main fluid channel and an inlet coupled to the main fluid channel for introducing fluid into the microfluidic circuit and at least one fluid chamber configuration. The fluid chamber configuration includes at least one fluid chamber, a fluid chamber inlet channel coupling the main fluid channel to an inlet of the fluid chamber, a fluid chamber outlet channel coupled to an outlet of the fluid chamber, a stop valve arranged in the main fluid channel downstream of the coupling with the fluid chamber inlet channel, where the stop valve blocks fluid at a pressure below a first burst pressure, and a flow restrictor in the fluid chamber outlet channel. The flow restrictor provides a back pressure higher than the first burst pressure of the pressure stop valve.

The invention relates to a microfluidic device. In particular, the invention relates to a microfluidic device having at least one fluid chamber.

Microfluidic devices have many different applications. As an example, they may be used to perform e.g. biological assay. In some applications, it is advantageous or even required to meter and/or compartmentalize, i.e. separate a portion of the liquid from the rest, an amount of fluid in the microfluidic device. In the art, metering and compartmentalization is achieved by placing the amount of fluid in a fluid chamber in a microfluidic circuit of the microfluidic device. To allow compartmentalization the microfluidic circuit may locally be provided with a functionalized surface. Alternative strategies rely on using gas permeable materials, oil, pumps or employing vacuum or centrifugal forces in order to separate a portion of material from the rest. In any case, such solutions are relatively complex.

A mechanical solution for compartmentalization has been provided in CN111389474B, however such a solution is still relatively complex since it requires three capillary burst valves for each fluid chamber.

The invention therefore has as its object to provide a microfluidic device which allows metering and compartmentalization and which is relatively less complex.

The object is achieved using a microfluidic device comprising a microfluidic circuit comprising a main fluid channel and an inlet coupled to the main fluid channel for introducing fluid into the microfluidic circuit and at least one fluid chamber configuration, wherein the fluid chamber configuration comprises:
at least one fluid chamber;
a fluid chamber inlet channel coupling the main fluid channel to an inlet of the fluid chamber;
a fluid chamber outlet channel coupled to an outlet of the fluid chamber;
a pressure stop valve arranged in the main fluid channel downstream of the coupling with the fluid chamber inlet channel, wherein the pressure stop valve is arranged to block fluid at a pressure below a first burst pressure;
a flow restrictor arranged in the fluid chamber outlet channel, wherein the flow restrictor is arranged to provide a back pressure which is higher than the first burst pressure of the pressure stop valve.

The above-described microfluidic device may be used by introducing a fluid, such as a liquid, in the inlet. The fluid will consecutively flow through the main fluid channel. The pressure stop valve in the main fluid channel prevents the fluid to flow beyond the pressure stop valve, until the first burst is reached. Accordingly, when the fluid reaches the pressure stop valve, additional fluid will flow into the fluid chamber inlet channel, which branches off from the main fluid channel upstream of the pressure stop valve arranged therein. From the fluid chamber inlet channel, the fluid chamber itself is filled with the fluid. When the fluid chamber is filled, the fluid continues in the fluid chamber outlet channel, where it reaches the flow restrictor. Since the flow in the fluid chamber outlet channel is restricted by the flow restrictor, the pressure in the fluid may be increased. In particular, the pressure may be increased to above the first burst pressure of the pressure stop valve in the main fluid chamber, which consequently will burst, thereby allowing fluid to continue flowing through the main fluid channel again. Accordingly, fluid in the main fluid channel can only continue to flow past the pressure stop valve once the fluid chamber is filled.

When introducing a second fluid, such as air, after the fluid in the inlet until air reaches the coupling of the fluid chamber inlet channel with the main fluid channel, the fluid chamber can be separated from the main fluid channel. Accordingly, the fluid is metered and compartmentalized, and may be used for e.g. assay if desired. Compartmentalization may also be achieved to a sufficient degree without introducing air after the fluid, because the fluid chambers will only be connected via the respective inlet channels and the main fluid channel, which is a relatively long path.

Notably, a pressure stop valve and a flow restrictor are employed, thereby providing a more elegant solution than that known from CN111389474B.

In particular, the microfluidic device may be pressure driven, i.e. the device may be configured to receive the fluid under an externally applied pressure. Such a pressure may exceed at least the first burst pressure, at least when the first stop valve is burst.

Expressions such as downstream and upstream are used throughout this application as defined during normal use of the microfluidic device. Therefore, downstream is a direction starting from the inlet and moving along the microfluidic circuit. Upstream therefore is a direction from some part of the microfluidic circuit moving towards the inlet.

The pressure stop valve may be arranged to substantially block fluid flow through the valve as long as the pressure difference over the pressure stop valve remains below the first burst pressure. When said pressure difference exceeds the first burst pressure, the pressure stop valve will open, thereby allowing fluid to flow through the valve. In some pressure stop valves, the valve will remain open as long as fluid is present in the valve, regardless of the pressure difference across the valve. The first burst pressure may therefore have a minimum, non-zero value, for instance a minimum value corresponding to a resistance to flow encountered in the fluid chamber inlet channel and the fluid chamber combined.

The first burst pressure is therefore such that the fluid chamber substantially fills before the first burst pressure is reached, and that the valve bursts when the pressure is increased beyond the first pressure.

Since the first burst pressure is smaller than the back pressure provided by the flow restrictor, the microfluidic circuit may function regardless of the size of the fluid chamber and its distance with respect to the main channel. As a result a distance may be introduced between the main fluid channel and the fluid chamber, the distance being spanned by the fluid chamber inlet channel. This may allow placing the fluid chamber away from the main fluid channel, which may prevent or reduce cross readings from the main fluid channel when performing an experiment in the fluid chamber. Cross readings may for instance occur during fluorescent measurements, where light from the one fluid chamber, or another part of the microfluidic device, may be detected by a sensor for another fluid chamber. By implementing the stop valve and the flow restrictor, a suitable length may be chosen for the fluid chamber inlet channel, and for the fluid chamber outlet channel in the event it leads back to the main fluid channel.

The flow restrictor may be any device or component that reduces, restricts or prevents the flow of the fluid. As an example, a narrowing in the fluid chamber outlet channel may function as a flow restrictor. By choosing a suitable length of the narrowing, the degree of flow restriction can be suitably chosen. In practice, the degree of flow restriction is chosen so that during normal use, the pressure drop across the flow restrictor is larger than the first burst pressure. Moreover, a valve could act as a flow restrictor by preventing fluid flow in one state, and allowing it in another.

It is noted that for some types of flow restrictors the pressure drop across the flow restrictor is dependent on some characteristics such as fluid flow and viscosity. Therefore, the back pressure provided by the flow restrictor may be defined during normal use, i.e. for aqueous liquids at a flow rate of between 0.01 ml/min and 10 ml/min, preferably between 0.1 ml/min and 1 ml/min. The burst pressure of other stop valves throughout this application may be defined at the same operating conditions.

The back pressure provided by the flow restrictor may be defined as the pressure drop over the flow restrictor, the corresponding fluid chamber, and the corresponding fluid chamber inlet channel. In the event the fluid chamber outlet channel is connected to the main fluid channel, a pressure drop across the flow restrictor and a pressure drop across the pressure stop valve are equal, so that the back pressure equals the pressure drop across the flow restrictor.

It is noted that the microfluidic circuit and in particular the flow restrictor and the pressure stop valve may be arranged to have a back pressure provided by the flow restrictor which is higher than the first burst pressure.

Further, the pressure stop valve may comprise a capillary stop valve. Capillary stop valves may be used to completely prevent the flow of liquid at least until the burst pressure is reached. An exemplary capillary stop valve may comprise hydrophobic layers, which induce capillary action in order to prevent or reduce liquid flow. Another type of capillary stop valves relies on geometry changes inducing capillary action, thereby requiring no further materials such as hydrogels or hydrophobic layers to be used.

It is noted alternatives exist for the pressure stop valve, so that it may also be left out. Also, it may be replaced by a flow restrictor or any other structure causing delay in the through flow of fluid, thereby promoting fluid to flow through the fluid chamber inlet channel.

As an example, a delay in flow in the main channel may be introduced, sufficient to allow filling of the at least one fluid chamber. The flow resistance to the fluid chamber is then preferably lower than a resistance through the delay structure. The chamber is thus filled.

Preferably, after a predetermined time period, preferably when the chamber is substantially filled, the liquid passes the delay structure and travels through the main channel, for instance in the direction of a next chamber and/or the chamber outlet channel connecting to the main channel.

In case the fluid chamber outlet channel feeds back to the main fluid channel, the delay may be configured such that a fluid in the main channel blocks the fluid chamber outlet channel before fluid coming from the at least one fluid chamber reaches the main fluid channel through the fluid chamber outlet channel. Accordingly, a bubble of e.g. air may be trapped in the fluid chamber outlet channel, by the fluid in the main channel on the one hand and fluid in the at least one fluid chamber and in the fluid chamber outlet channel on the other hand.

The delay may be introduced by any suitable means, such as a delay valve. Delay valves as such are known, and may for instance include a liquid soluble material blocking the main fluid channel, which dissolves after some time in contact with the fluid in the main channel. Another type of delay valve constitute a relatively long and narrow channel, particularly in the case the microfluidic chip is driven by an outside pressure in stead of by capillary pressure.

In case the pressure stop valve is done away with, and for instance replaced by a delay, the flow restrictor may be arranged such that the at least one fluid chamber fills at least almost completely before fluid in the main channel continues flowing, or before the fluid in the main channel reaches the fluid chamber outlet channel in case it feeds back to the main channel.

Alternatively, a liquid triggered valve may be arranged in the main channel, wherein the liquid triggered valve is arranged to open upon contact with liquid at the downstream side thereof. This liquid may reach the valve when flowing from the chamber outlet channel back into the main channel towards the liquid triggered valve. The valve is thus only triggered when the chamber is completely filled, and overflow liquid reaches the main channel through the chamber outlet channel.

The skilled person will therefore recognize that the pressure stop valve may be replaced by a main channel flow restrictor. The main channel flow restrictor and the previously introduced flow restrictor in the fluid chamber outlet channel may then be arranged so that the at least one fluid chamber is filled at least almost completely, and optionally to prevent flow from the fluid chamber outlet channel to the main channel. The particular design of the flow restrictor and the main channel flow restrictor may be based on pressure or delay, as was introduced as two alternatives above. Of course, a combination between the embodiments may also be employed.

In an embodiment of the microfluidic device, the flow restrictor comprises a pressure stop valve. By using a stop valve, fluid flow can be stopped completely, thereby rendering the microfluidic device robust with regards to timing differences, which may ease design constraints and/or more clearly define the amount of liquid needed before the pressure stop valve may be burst.

In particular, the flow restrictor may comprise a capillary stop valve, thereby allowing an elegant design and/or dispensing with the need for hydrogel or hydrophobic layers. Additionally or alternatively, a second burst pressure may be defined for the pressure stop valve in the fluid chamber outlet channel, in particular in the case of the capillary stop valve, which is higher than the first burst pressure.

Accordingly, the pressure in the liquid can be increased gradually until the first burst pressure is reached, so that the stop valve in the fluid chamber outlet channel need not burst, thereby containing fluid in the chamber.

In another embodiment of the microfluidic device, the fluid chamber outlet channel couples the outlet of the fluid chamber to the main fluid channel at a location downstream of the pressure stop valve.

By coupling the outlet channel to the main fluid channel, air may be let out of the fluid chamber, and the fluid chamber inlet channel and the fluid chamber outlet channel in order to allow fluid to enter the fluid chamber inlet channel. An alternative way to allow air to exit, is to provide a separate vent for the fluid chamber outlet channel. It may however be advantageous when the fluid chamber outlet channel couples back to the main fluid channel, as they may accordingly share a vent leading to a more efficient design. Moreover, in the event that a superfluous amount of fluid would be introduced into the fluid chamber inlet channel, the outlet feeding back to the main fluid channel prevents leaking.

Of course, the outlet channel may couple to the main fluid channel either upstream or downstream of a next fluid chamber inlet channel. In both these cases, the above described advantages may be achieved. In particular, the fluid chamber outlet channel of multiple fluid chambers may connect downstream of another, for instance the last, fluid chamber inlet channel.

An advantageous device is obtained if downstream of the fluid chambers an overflow reservoir such as one described herein, wherein the fluid chamber outlet channel(s) of the fluid chamber(s) couple to the overflow reservoir. The main fluid channel also couples to the overflow reservoir, so that the fluid chamber outlet channels are effectively coupled to the main fluid channel. This achieves the above described effect of needing only a single vent and reducing the likelihood of e.g. leaks.

In particular, the flow restrictor may extend in the fluid chamber outlet channel at a distance from the coupling to the main fluid channel.

By arranging the flow restrictor at a distance of the main fluid channel, an air bubble is maintained between a fluid front in the fluid chamber outlet channel and the fluid in the main fluid channel. The air bubble accounts for effective separation between fluid in the fluid channel and fluid in the main fluid channel, thereby contributing to effective compartmentalization.

More in particular, the flow restrictor may extend in the fluid chamber outlet channel at a distance from the outlet of the fluid chamber.

Arranging the flow restrictor at a distance from the fluid chamber may guarantee that the fluid chamber is completely filled before the fluid reaches the flow restrictor. Because the first burst pressure can only be achieved once the flow restrictor is reached, this position of the flow restrictor ensures the fluid chamber is suitably filled before the first burst pressure is reached. Accordingly, the fluid is correctly metered in the fluid chamber.

In another embodiment of the microfluidic device, the device comprises a plurality of fluid chambers coupled to the main fluid channel, wherein each of the chambers is provided with a respective fluid chamber inlet channel and with a respective outlet channel provided with a flow restrictor.

Having a plurality of fluid chambers may allow to perform multiple tests, for instance different tests, on portions of the same original sample.

In particular, at least two fluid chambers may be arranged at opposite sides of the main fluid channel and they may be coupled thereto with respective fluid chamber inlet channels.

By arranging fluid chambers on opposing sides of the main fluid channel, a relatively large distance between the fluid chambers can be created with channels of relatively short length. The relatively large distance between the fluid chambers may be used to counteract or prevent interference if tests are performed simultaneously on the fluid in the two opposing fluid chambers.

In yet another embodiment of the microfluidic device, the at least one fluid chamber configuration further comprises:
a second fluid chamber;
a second fluid chamber inlet channel coupling the main fluid channel to an inlet of the second fluid chamber, wherein the pressure stop valve in the main fluid channel is also arranged downstream of the coupling with the second fluid chamber inlet channel;
a second fluid chamber outlet channel coupled to an outlet of the second fluid chamber;
a second flow restrictor arranged in the second fluid chamber outlet channel, wherein the second flow restrictor is arranged to provide a back pressure which is higher than the first burst pressure of the pressure stop valve in the main fluid channel.

In this embodiment, a second fluid with similar functionality is introduced without requiring an additional pressure stop valve in the main fluid channel. Accordingly, a single pressure stop valve in the main fluid channel may be used in a single fluid chamber configuration.

The second fluid chamber inlet channel may comprise a pressure stop valve, preferably a capillary stop valve, having a third burst pressure which is lower than the first burst pressure of the pressure stop valve in the main fluid channel.

Providing the pressure stop valve in the inlet channel of the second fluid chamber prevents fluid from entering said fluid chamber until the third pressure burst is reached. Accordingly, fluid enters the first fluid chamber first, until it reaches the flow restrictor. As the pressure increases, the third burst pressure is reached and fluid enters the second fluid chamber until its flow restrictor is reached. Only then can sufficient pressure be reach to exceed the first burst pressure. Accordingly, the second pressure stop valve allows defining a filling order for the chambers. Consequently, if a sample is provided that is too small to fill both fluid chambers, it may be ensured that at least one fluid chamber is completely filled, thereby contributing to the robustness of the microfluidic device.

In yet another embodiment of the microfluidic device, the first and second fluid chamber inlet channels are coupled to the main fluid channel at substantially the same longitudinal location of the main fluid channel and/or the first and second fluid chamber outlet channels are coupled to the main fluid channel at substantially the same longitudinal location of the main fluid channel.

By providing the inlet and/or outlet channels at the same longitudinal location, a relatively compact design can be achieved.

The microfluidic device may comprise a plurality of fluid chamber configurations coupled to the main fluid channel.

Using a plurality of fluid chamber configurations allows performing multiple of the same or different tests on a single sample introduced in the main fluid channel.

The plurality of fluid chamber configurations are arranged in series along the main fluid channel, wherein a pressure stop valve of a fluid chamber configuration is arranged upstream of a fluid chamber inlet channel of a subsequent fluid chamber configuration.

Accordingly, fluid chambers of different ones of the plurality of fluid chamber configurations can be filled consecutively. As a result, when a too small sample is used, it can be ensured that the fluid chambers located upstream are filled completely before fluid is introduced in other fluid chambers.

In another embodiment, multiple fluid chamber configurations are provided along the length of the main fluid channel, however at least some of the fluid chamber configurations which are arranged at different positions along the main fluid channel, share the same single pressure stop valve. In such a configuration, the single pressure stop valve can ensure filling of all upstream fluid chambers in one go. It has been found that such a design is less error prone, meaning that a more reliable filling of the fluid chambers is obtained.

Such an embodiment comprises at least two fluid chamber configurations having fluid chamber inlet channels coupled to the main fluid channel at different positions along the main fluid channel, and a single pressure stop valve in the main fluid channel for said at least two fluid chamber configurations downstream of the inlet channels of the at least two fluid chamber configurations. Without referring to the direction of flow, it can be said that all of the at least two fluid chamber configurations couple to the main fluid channel on a single side of the shared single pressure stop valve in the main fluid channel. Said pressure stop valve is arranged further from the inlet than the fluid chamber configurations.

The reliability of filling is increased even further if a single pressure stop valve is provided in the main fluid channel for all fluid chambers. All fluid chambers may therefore be coupled with their fluid chamber inlet channels to the main fluid channel upstream of the pressure stop valve, whereas the fluid chamber outlet channels are coupled to the main fluid chamber downstream of the pressure stop valve. The latter coupling may take place for instance at an overflow reservoir in which the main fluid channel debouches.

The microfluidic circuit may further comprise an overflow reservoir coupled downstream of the main fluid channel and/or a vent. The vent may be disposed downstream of the main fluid channel and downstream of the overflow reservoir if it is provided. The vent may allow air to exit the circuit in order to allow for the introduction of fluid. The overflow reservoir may prevent superfluous fluid from escaping the microfluidic device, thereby making the microfluidic device relatively easy to use and therefore more suitable for home or point of care applications. The vent and/or the overflow channel may be coupled to the main fluid channel.

The invention also relates to an assembly of a microfluidic device as described above and a fluid, and to a method of using such a device or assembly.

The invention also relates to a method of at least partially filling a fluid chamber in a microfluidic device as described above, the method comprising:
introducing fluid in the main channel through the inlet;
blocking the fluid in the main channel using the pressure stop valve arranged therein;
filling said fluid chamber via its fluid chamber inlet channel;
restricting flow through the outlet channel of said fluid chamber, optionally with the use of a flow restrictor; and
bursting the pressure stop valve in the main fluid channel.

The method may be performed using a microfluidic device as described above. The method may offer the above-described advantages. In particular, the method may allow to meter and/or compartmentalize a portion of a sample in the fluid chamber, whilst the rest of the sample may proceed through the main fluid channel.

Introducing the fluid in the main channel may comprise:
providing the fluid in or near the inlet of the microfluidic device;
forcing the fluid into the microfluidic circuit of the microfluidic device through the inlet, whilst allowing fluid to vent through a vent of the microfluidic circuit;
sealing the inlet and the vent using a cap.

By sealing the inlet and the vent using a cap, leaking is prevented.

The fluid allowed to vent may be fluid, for instance air, already present in the microfluidic circuit. Allowing said fluid the vent allows filling the microfluidic circuit. The step of forcing the fluid into the microfluidic circuit may be performed using the cap.

The step of forcing the fluid into the microfluidic circuit may comprise the subsequent steps of:
introducing liquid in the microfluidic circuit for filling at least two fluid chambers;
introducing a gas in the main channel of the microfluidic circuit for compartmentalizing the at least two liquid filled fluid chambers.

By introducing a gas, such as air, after the liquid into the microfluidic circuit, the gas can at least partially fill the main fluid channel, thereby cutting off a fluid connection between the at least two fluid chambers. Accordingly, reagents from the one fluid chamber can not contaminate the other. Moreover, cutting of the liquid connection between the chambers may contribute to more accurate metering.

In order to introduce fluid, particularly liquid, into the microfluidic circuit, the microfluidic device may be part of an assembly further comprising a cap, and a pumping mechanism, which optionally comprises the cap, wherein the pumping mechanism is arranged to introduce fluid through the inlet into the microfluidic circuit, wherein preferably the cap is movable between a first position, in which it leaves free at least the inlet and optionally the vent, a second position, in which the pumping mechanism engages the microfluidic device and seals the inlet but not the vent, and a third position in which the cap seals the inlet and the vent.

The pumping mechanism may be configured to provide e.g. a sample in a suitable amount, such as a predetermined amount, to the microfluidic circuit. The pumping mechanism may be configured to provide a pressure sufficient to burst the pressure stop valve.

The pumping mechanism may be used to introduce fluid into the microfluidic circuit. Accordingly, the cap and the microfluidic device may be relatively easy to use, as no other appliances, such as pumps, are needed in order to introduce fluid into the microfluidic circuit. This embodiment therefore further improves the microfluidic device as described above by facilitating use of the assembly in home or point of care environments by increasing its ease of use.

Additionally or alternatively, using the pumping mechanism of the cap may allow a relatively controlled introduction of the fluid into the microfluidic circuit, for instance, the amount of liquid introduced may be limited by the design of the cap.

The pumping mechanism may be configured to supply a predetermined amount of liquid, for instance an amount between a minimum and a maximum, to the microfluidic circuit. The pumping mechanism may be configured to supply sufficient liquid to fill at least one fluid chamber, more than one fluid chambers, or all fluid chambers.

The pumping mechanism may be configured to supply less than a maximum amount of fluid, the maximum for instance corresponding to the total volume of the microfluidic circuit. In case the pumping mechanism is configured to supply a gas, such as air, after the fluid, the total volume of the gas and the fluid may be less than the maximum.

According to this embodiment, the cap performs a threefold functionality of sealing the inlet, sealing the vent, and pumping fluid into the microfluidic circuit.

In such an assembly, it is preferred the microfluidic circuit also comprises a vent. In that case, the cap may be configured to seal the inlet and the vent.

By sealing both the inlet and the vent, leaking of the microfluidic device is reduced or prevented entirely. Moreover, when the cap seals the inlet and the vent, no material may enter or exit through the inlet or the vent, thereby allowing a better control of any functioning of the microfluidic device. This is particularly important when using nucleic acid amplification such as PCR or LAMP. If the amplified products would leak, or evaporate, from the device, they can contaminate a whole room and result in false positives for further tests. Accordingly, the assembly may be used relatively easily even outside lab environments, such as home or point of care environments.

The fluid chamber configuration(s) and the main fluid channel are examples of functional components of the microfluidic circuit, however other functional components may also be present. As such, below the general term functional components will be used where appropriate.

The microfluidic circuit may include the inlet on one end, the vent on another end, with the functional component in between. More than one functional component may be present. The functional component may for instance include a reaction chamber, for instance provided with a reactant, a sensor, or any other component allowing functioning of the microfluidic device. The microfluidic circuit may have one or more other components such as channels, reservoirs, valves, MEMS's, etc.

The microfluidic device may comprise a plurality of inlets and/or vents. The cap is then preferably arranged to seal the plurality of inlets and/or vents. It is for instance possible that the microfluidic device comprises a microfluidic circuit with a plurality of vents. The device may also comprise a plurality of microfluidic circuits, for instance each provided with a respective inlet and vent.

Details of cap and the microfluidic device will be described below by referring to specific embodiments of the assembly. The application however also relates to the cap and the microfluidic device outside of the context of the assembly. As such, all details described below with reference to the cap and/or the microfluidic device may be applied to the cap and device respectively as described herein, alone or in any suitable combination. Embodiments of the cap and/or microfluidic device may overlap with embodiments of the assembly.

The vent may be open to the exterior of the microfluidic device, so as to allow e.g. air to exit from the microfluidic circuit when fluid is introduced at the inlet.

Since the vent can be sealed by the cap, there is no need to place a liquid impermeable membrane, capillary stop valve or other liquid stopping means such as an additional cap at the vent, thereby making the microfluidic device relatively elegant in design.

In a practical embodiment of the assembly or the cap, the cap comprises a circumferential wall and an end surface connected to the circumferential wall.

In another embodiment of the assembly or the cap, the cap comprises a protrusion for sealing the vent, the protrusion optionally protruding from a free end of the circumferential wall for sealing the vent. The cap having a protrusion may allow a positive engagement of the vent, thereby creating a relatively reliable seal. The protrusion may protrude from any part of the cap, however it is particularly advantageous if the protrusion protrudes from said free end, as this may allow introducing the protrusion into the vent using the same motion as applying the cap to the device. Accordingly, a single movement may suffice for sealing the inlet and the vent.

The protrusion may have an external dimension exceeding an internal dimension of the vent. Accordingly, the protrusion can be forced at least partly into the vent upon deformation of the protrusion and/or the vent, thereby achieving a relatively reliable sealing.

In yet another embodiment of the assembly or the cap, the circumferential wall has a height defined from the end surface to its free end, wherein the local height of the circumferential wall is at a maximum at and/or near the protrusion.

In this embodiment, the circumferential wall is highest at or near the protrusion. Accordingly, said part of the circumferential wall is closest to the microfluidic device when the cap is applied to the microfluidic device. As a result, the protrusion may contact the vent first, i.e. before other parts of the cap contacting the vent. As such, a relatively large amount or even all of the pressure with which the cap is applied to the microfluidic device is transferred to the protrusion and the vent. Accordingly, the protrusion may seal the vent relatively reliably.

In yet another embodiment of the assembly or the cap, a pumping mechanism is provided, the pumping mechanism optionally comprising the cap, wherein the pumping mechanism is arranged to introduce fluid through the inlet into the microfluidic. The cap may function as a piston of the pumping mechanism, while a part of the microfluidic device, such as the upstanding edge or inlet, may function as a pumping chamber. Preferably, the cap is movable between a first position, in which it leaves free at least the inlet and optionally the vent, a second position, in which the pumping mechanism engages the microfluidic device and seals the inlet but not the vent, and a third position in which the cap seals the inlet and the vent.

In yet another embodiment of the assembly, the pumping mechanism together with the microfluidic device defines an enclosed volume fluidically connected to the inlet in the second position of the cap, and the enclosed volume is reduced as the cap is moved towards its third position, thereby creating a pumping action.

Reduction of the volume may bring about an increase in pressure, thereby providing a pumping action for introducing the fluid into the microfluidic circuit. The amount of reduction of the volume can be suitably chosen to limit the maximum volume of fluid introduced, so that the introduction can be controlled.

The reduction of the volume may be approximately equal to or exceed a combined volume of the functional element, or if more functional elements are provided, of the functional elements, and the channels leading up to the functional element(s) from the inlet. Optionally, the reduction in volume may not exceed a total volume of the microfluidic circuit.

In yet another embodiment of the assembly, the assembly further comprises at least one stop defining a respective intermediate position of the cap between the second and third position.

Defining an intermediate position using a stop allows a user to notice relatively easily when the intermediate position is reached. The intermediate position can be used for instance to have the user wait for a predetermined period before moving the cap further towards the third position, i.e. before pumping further. As such, a multi-step pumping process may be achieved with the aid of the stop. The waiting period may be used to allow sample material to progress into the microfluidic circuit, thereby reducing pressure in the microfluidic circuit. The reduced pressure may prevent or reduce damage to the microfluidic circuit, or may be advantageous to the functioning of e.g. the functional element. In particular when a microfluidic circuit is to be filled comprising a plurality of chambers, possibly interconnected by pressure stop valves as described above, such a waiting period is preferred. This allows efficient filling of the circuit.

The stop may be formed by a mechanical interaction between the cap and the microfluidic device. As an example, one of the microfluidic device and the cap may comprise a guide slot, the other of the microfluidic device and the cap comprising a follower engaging the slot, wherein the slot defines an arcuate or angled shape, so that the stop is formed by the arcuate or angled shape of the slot. As such, it is possible to move the cap towards the third position initially in a first direction until the arcuate or angled shape is reached. The shape of the slot prevents further movement in the same direction at this position of the cap, thereby thus providing a stop and defining the intermediate position. Changing a direction of the cap in accordance with the shape of the slot allows moving beyond the intermediate position further towards the third position.

In an embodiment, the cap is movable from the at least one intermediate position towards the third position by rotating the cap with respect to the microfluidic device.

Allowing the cap to move beyond the intermediate position only after rotation thereof, may aid in preventing inadvertently bypassing the at least one intermediate position.

Referring to the slot-and-follower example above, a first segment of the slot may extend in an axial direction of the cap to allow moving the cap towards the microfluidic device from the second position to an intermediate position. Then, a second segment of the slot may extend in a circumferential direction of the cap, requiring rotation of the cap to move beyond the intermediate position. Finally, a third segment of the slot may extend in the axial direction, allowing moving the cap closer to the microfluidic device again. Multiple such intermediate positions may be defined, each having their own stop.

In an embodiment of the assembly or the cap, the pumping mechanism comprises an internal rim extending from a or the end surface of the cap, the internal rim defining an interspace between the internal rim and the circumferential wall.

The internal rim may allow engagement of the pumping mechanism before the cap has reached the third position. Moreover, the internal rim may provide a surface for sealing against a part of the microfluidic device, such as the upstanding edge described below. The upstanding edge may be arranged in the interspace, thereby creating a relatively reliable seal. The interspace may decrease in size in a direction from the free end of the internal rim to the end surface.

Owing to such a decreasing size, the interspace has a tapering shape which allows creating a more and more reliable seal on the upstanding edge when it is moved further into the interspace. In order to provide the decrease in size of the interspace, the internal rim may have an outer dimension which increases in said direction. It is possible to apply the increasing outer dimension of the internal rim regardless of the increase or decrease in size of the interspace.

In yet another embodiment of the assembly or the cap, the pumping mechanism further comprises a web spanning the internal rim.

The web spanning the rim may seal the internal rim, thereby allowing the internal rim to enclose a volume together with the microfluidic device when the internal rim engages on the microfluidic device, e.g. in the second position of the cap. Then, by reducing said enclosed volume a pressure can be created which generates a pumping action.

The web may be arranged at a distance from the end surface in order to limit the size of the enclosed volume. Limiting the size of the enclosed volume limits the amount of air in the enclosed volume when pumping starts. By limiting the amount of air, a build up of energy in the air required for compressing of the air during pumping is limited. Accordingly, less pressure is needed for pumping the fluid, further contributing to the ease of use of the cap and/or assembly.

The web may be arranged at a distance from a free end of the internal rim. As a result, the free end of the internal rim may deform relatively easily. Accordingly, a deformation of the free end of internal rim may be used to create a reliable seal against a part of the microfluidic device. Allowing deformation of the internal rim in turn allows fabrication of the cap and/or the microfluidic device with more room for tolerance, whilst still providing a relatively reliable sealing.

The web may have a convex shape as seen from the free end of the internal rim. The convex shape may aid in providing sufficient strength of the web for providing pressure for pumping.

Preferably, the cap is manufactured from a plastic, for instance using an injection moulding process. The configuration of the cap and the inlet allows an efficient pumping and sealing mechanism without requiring softer, elastomeric sealing means as used in Begolo et al. (The pumping lid: Investigating multi-material 3D printing for equipment-free, programmable generation of positive and negative pressures for microfluidic applications” by S. Begolo et al., DOI: 10.1039/C4LC00910J (Lab on a Chip, September 2014).

In yet another embodiment of the assembly or the microfluidic chip, the microfluidic chip comprises a receiving space for receiving the cap, wherein the inlet and the vent are arranged in the receiving space.

Arranging the vent and the inlet in the receiving space may allow sealing the inlet and the vent with the same, single cap.

The inlet and the vent being arranged in the receiving space may mean the microfluidic circuit debouches to the exterior of the microfluidic device at the receiving space at its inlet and at its vent.

In order to arrange the vent close to the inlet, for instance sufficiently close to the inlet to seal the inlet and the vent with the same cap, the microfluidic circuit may comprise a return channel leading to the vent from e.g. a position further away from the inlet, for instance downstream of the functional component.

In yet another embodiment of the assembly or the microfluidic chip, the microfluidic chip comprises an open reservoir, the reservoir comprising the inlet, wherein the cap is configured to seal the inlet by sealing the reservoir.

By providing a reservoir, a user can relatively easily load the microfluidic device with a fluid. In particular, a user may be able to provide a sample, such as a saliva, blood or other sample in the reservoir. The reservoir comprising the inlet may allow moving the sample through the inlet into the microfluidic circuit upon application of a pumping force on the reservoir. When the reservoir comprises the inlet, the inlet can be sealed by sealing the reservoir.

When pumping fluid into the microfluidic circuit, it is not strictly necessary to completely empty the reservoir. In particular, some air may remain. Additionally, when a relatively large amount of sample material is provided in the reservoir, only a part of the sample material may be introduced into the microfluidic circuit when the cap is attached thereto. The reservoir may therefore also act as a way to store superfluous sample material and/or remaining air.

The size of the reservoir, in combination with the displacement of the cap with respect to the reservoir, defines the amount of sample moved from the reservoir into the microfluidic circuit. Thus, by adjusting the cap and the reservoir, it is possible to pump a desired amount of sample material into the microfluidic circuit. Accordingly, the pumping mechanism may be configured to pump a predefined amount of liquid, for instance corresponding to an amount of sample required to fill one, more or all fluid chambers in the microfluidic device. The pumping mechanism may be further configured to pump a predefined amount of gas, preferably after pumping the predefined amount of liquid.

By selecting a suitable size for the reservoir, and the point at which the cap engages the reservoir, the predefined amount of liquid and gas to be pumped can be chosen. The ratio of liquid to gas can be defined by a filling level of the reservoir, for instance indicated by an filling level indicator.

The inlet may be arranged at a bottom of the reservoir. Arranging the inlet at the bottom of the reservoir allows at least partly draining the reservoir whilst introducing little or no air to the microfluidic circuit.

The reservoir may be defined by an upstanding edge. The upstanding edge may provide a suitable surface for engaging the cap thereon. The upstanding edge may protrude from a surface, optionally a top surface of the microfluidic device.

In yet another embodiment of the assembly, the upstanding edge and the internal rim and/or the circumferential wall are configured to engage when the cap seals the inlet and the vent. A positive sealing may be achieved by engagement of the internal rim and the upstanding edge.

The upstanding edge may have a thickness which decreases in a direction from the inlet to a free end of the upstanding edge. Accordingly, the upstanding edge may have a tapering shape. The tapering shape allows increasing the engagement of the upstanding edge with the cap when the cap is moved from the free end of the upstanding edge towards the inlet. Accordingly, a more and more reliable seal may be achieved by forcing the cap against the tapering upstanding edge.

In particular, the internal rim and/or the upstanding edge may be shaped to deform under engagement when the cap seals the inlet and the vent.

When the rim and/or edge are shaped in order to deform under engagement, either one or both elements may be designed with a relatively large tolerance without hindering the sealing action of the engagement. Moreover, the deformation may cause the cap and microfluidic device to clamp onto each other, thereby making it more difficult to remove the cap.

In yet another embodiment of the assembly, the microfluidic device and the cap comprise mutually cooperating connecting elements, preferably configured for allowing connection but not disengagement.

Using the mutually cooperating connecting elements, inadvertent disengagement of the cap may be prevented. Moreover, the connecting elements may allow a user to easily ascertain the cap has been connected properly to the microfluidic device.

When the mutually cooperating connecting elements are configured for allowing connection but not disengagement, one time use of the assembly can be guaranteed or encouraged. Moreover, by preventing or discouraging removal of the cap, inadvertent influences on the functioning of the microfluidic device and/or may be prevented. Alternatively of additionally tampering may be complicated or prevented.

The mutually cooperating connecting elements may comprise snap-hooks on the cap and/or the microfluidic device.

Snap-hooks can be used to provide the above-described single use configuration, and may at the same time provide haptic and/or audible feedback indicating to a user the cap has been properly connected.

In yet another embodiment of the assembly or the microfluidic device, the microfluidic device comprises at least one guide guiding the cap with respect to the microfluidic device to a sealing position.

The guide may be used to align the cap with the microfluidic device, e.g. for allowing the protrusion to align with the vent, thereby making it relatively easy to apply the cap. The sealing position may correspond to the above-describe third position.

The invention also relates to a cap for sealing a microfluidic device with a microfluidic circuit having at least an inlet and a vent, the cap being configured for sealing the inlet and the vent.

The cap may be used to create a relatively easy to use assembly, in which only one cap needs to be used for sealing the inlet and the vent, thereby preventing leaks.

In particular, the cap may be used in the assembly as described above. The cap may therefore have the features described above in relation to the assembly or the cap in particular, alone or in any suitable combination.

The invention also relates to a microfluidic device which has the features pertaining to the microfluidic device described above in relation to the assembly or to the microfluidic device in particular. The features may be applied to the microfluidic device alone or in any suitable combination, for instance in combination with the features of the described outside of the scope of the assembly.

Such a microfluidic device may in particular allow relatively easy use thereof, since the inlet and vent may be sealed using a single cap.

The invention also relates to a method for introducing fluid into a microfluidic device, preferably using an assembly as described above, the method comprising:
a) providing the fluid in or near an inlet of the microfluidic device;
b) forcing the fluid into a microfluidic circuit of the microfluidic device through the inlet, whilst allowing fluid to vent through a vent of the microfluidic circuit;
c) sealing the inlet and the vent using a cap.

By sealing both the inlet and the vent, leaking of the microfluidic device is prevented. Accordingly, the method may be relatively easy to perform outside lab conditions, thereby making it suitable for use in e.g. home or point of care environments.

In an embodiment of the method, step c) is performed using the cap. By forcing the liquid into the microfluidic circuit using the cap, a pumping action can be achieved by the cap, for instance when it is applied to the microfluidic device. As a result, no further equipment may be needed to use the microfluidic device, thereby making the method of this embodiment even more easy to perform in home or point of care environments.

The method of using the device or assembly defined above may comprise said method for introducing fluid into a microfluidic device, for instance for filling fluid chambers thereof.

The invention will be further elucidated with reference to the figures, in which:

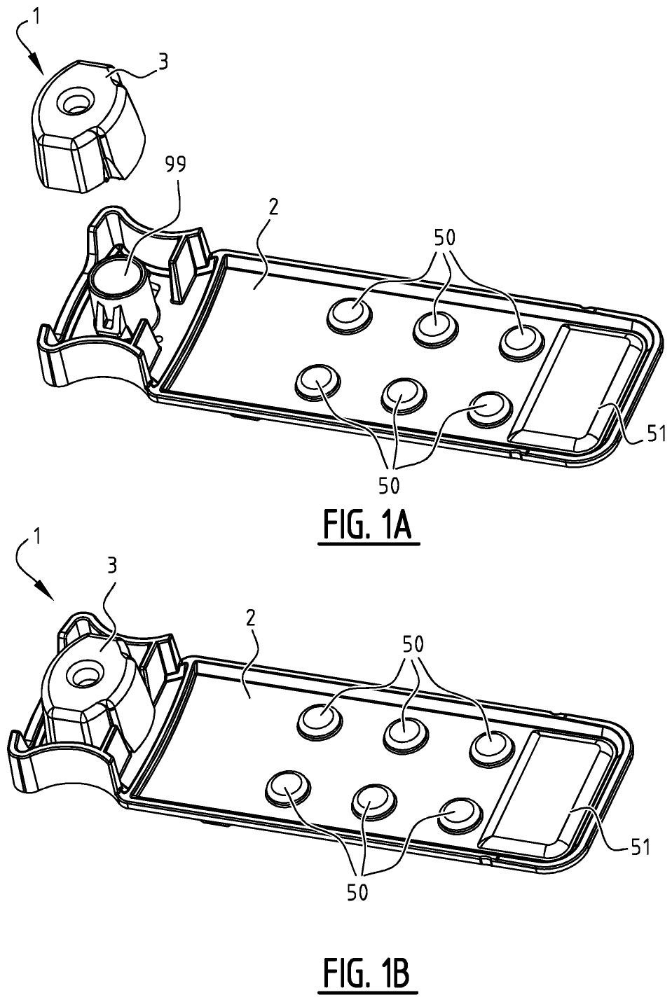

FIGS. 1A and 1B schematically show a perspective view of a microfluidic device and a cap, wherein in FIG. 1A the cap is removed from the microfluidic device, and in FIG. 1B the cap is applied to the microfluidic device;

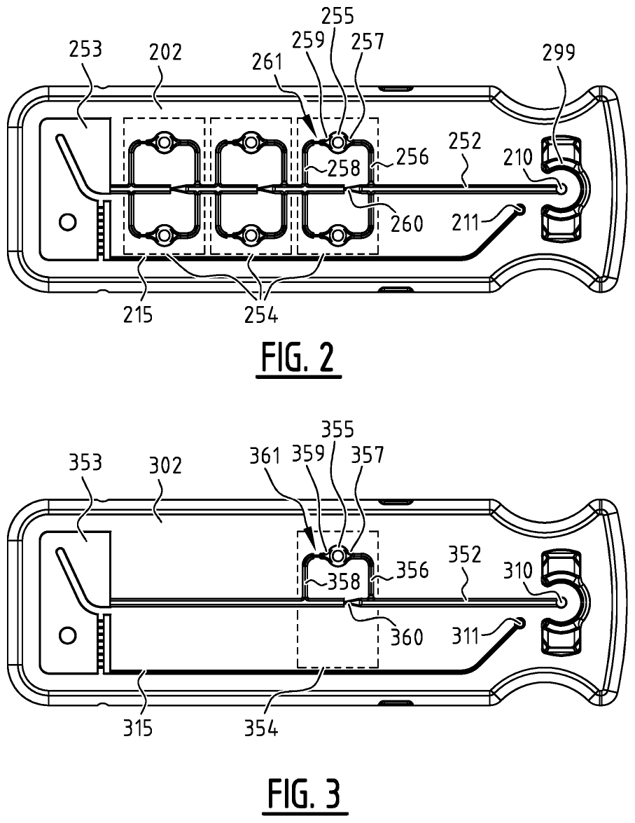

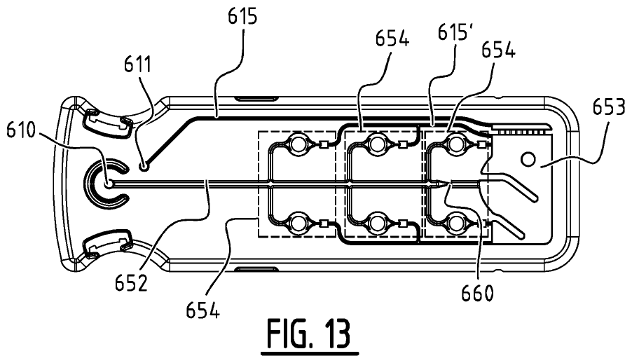

FIGS. 2-5A and B and FIG. 13 schematically show bottom views of different embodiments of the microfluidic device of FIGS. 1A and 1B;

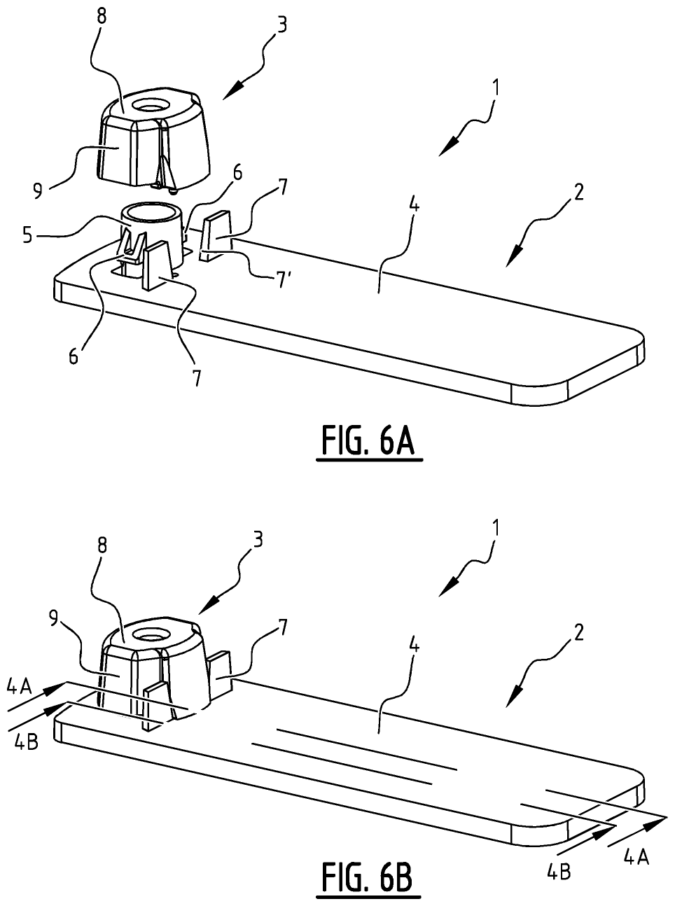

FIGS. 6A and 6B schematically show perspective views of a simplified microfluidic device and a cap, wherein in FIG. 6A the cap is removed from the microfluidic device, and in FIG. 6B the cap is applied to the microfluidic device;

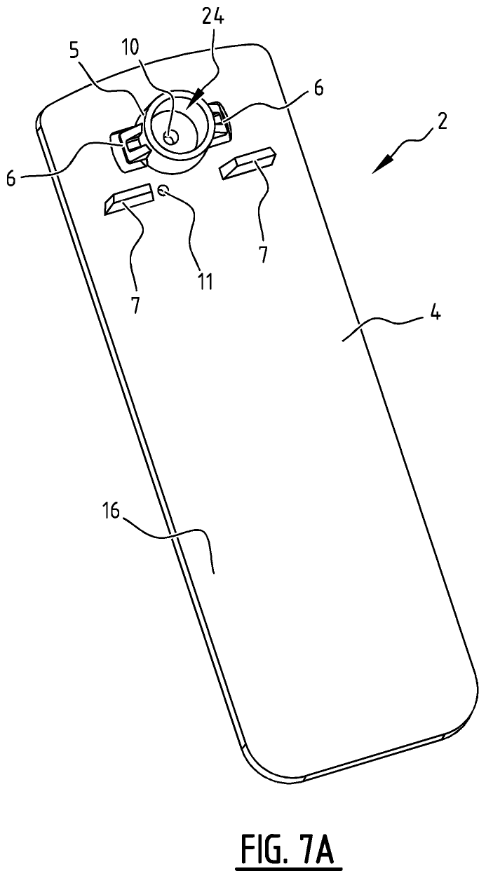

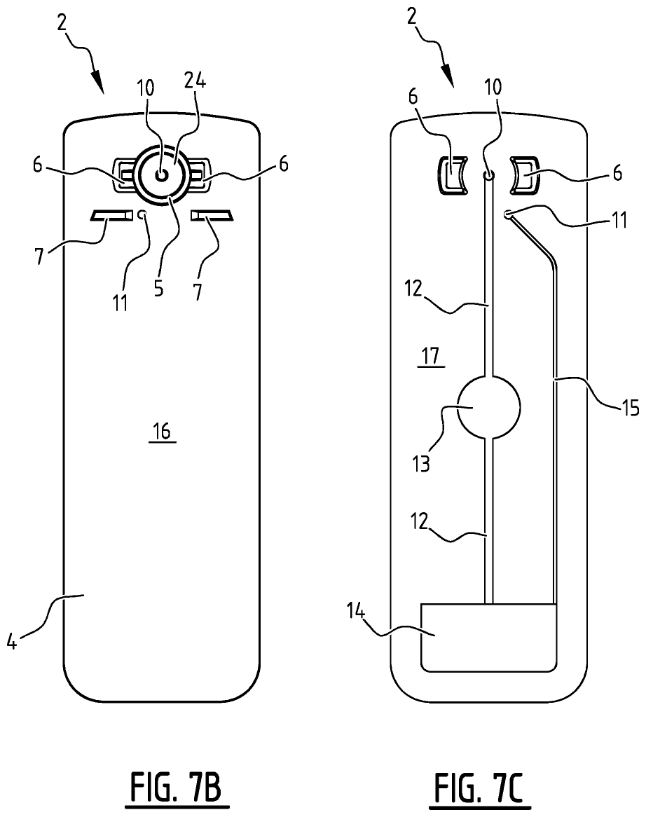

FIGS. 7A-7C schematically show a perspective, top and bottom view of the simplified microfluidic device respectively;

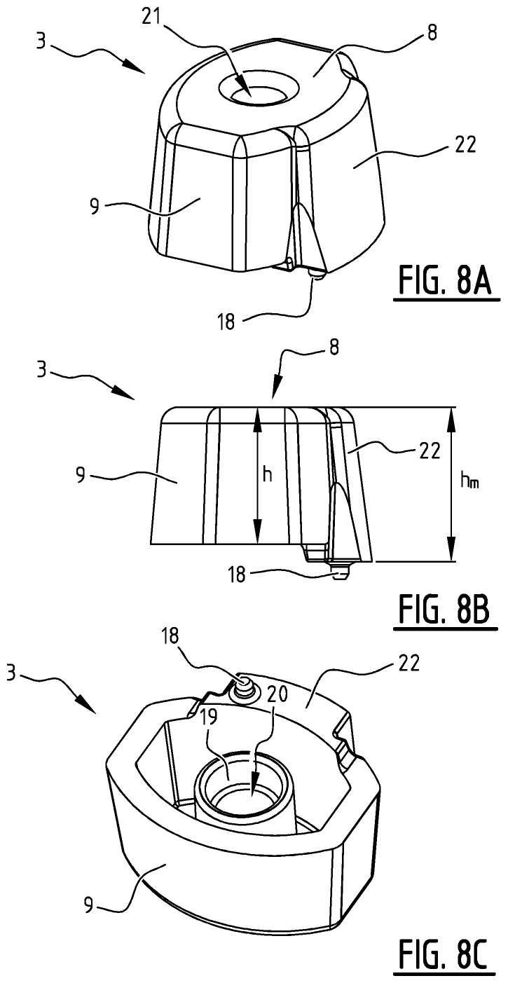

FIGS. 8A-8C schematically show a perspective view, a side view of the cap and another perspective view respectively, wherein in FIG. 8C the cap is viewed upside-down;

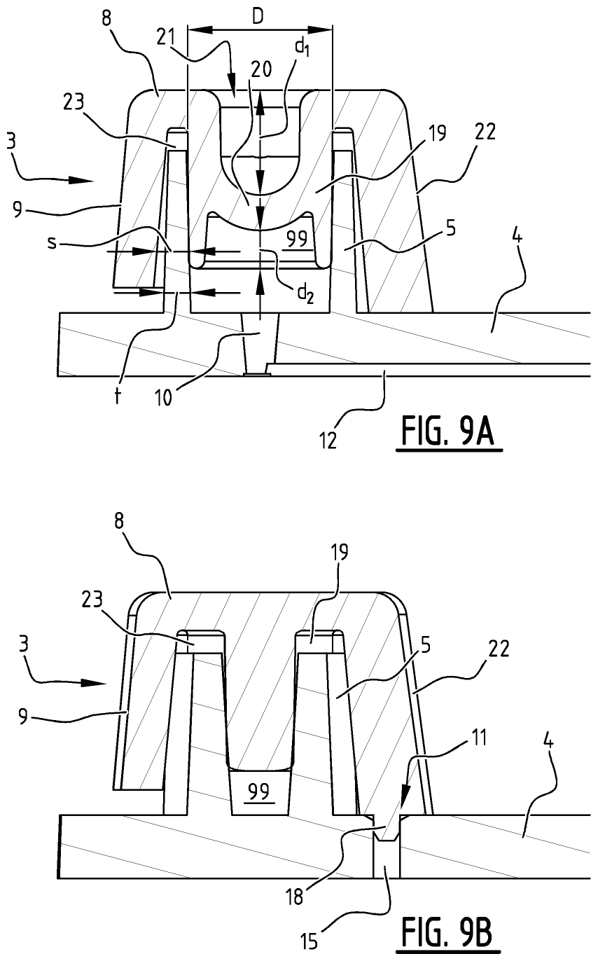

FIGS. 9A and 9B schematically show cross sections of the cap and the simplified microfluidic device;

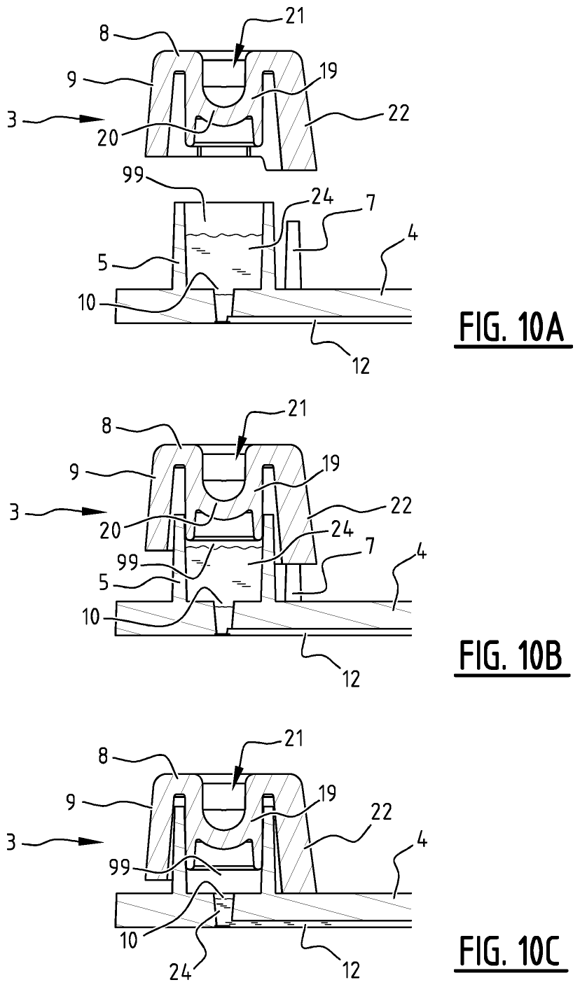

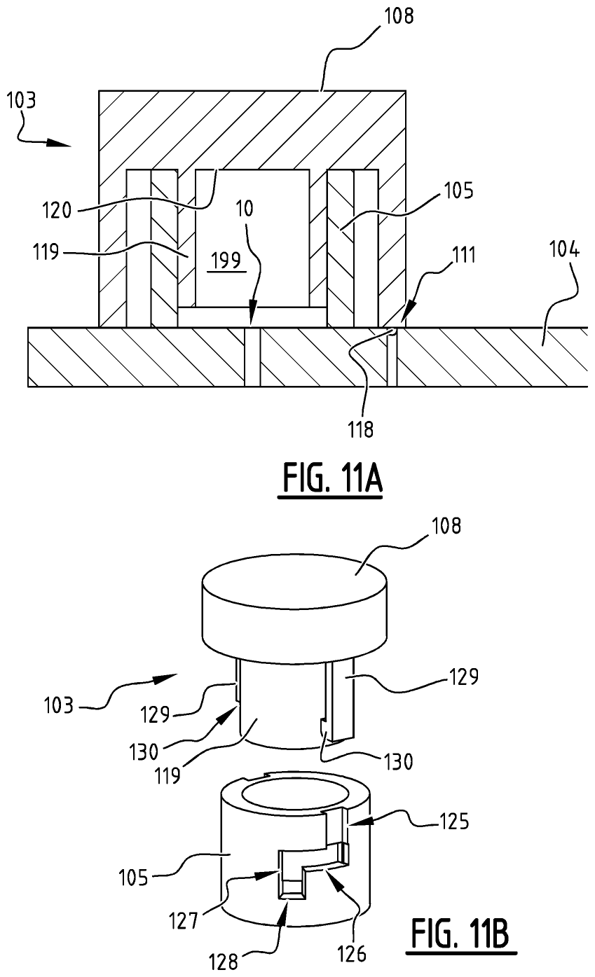

FIGS. 10A-10C schematically show cross sections of the cap and the simplified microfluidic device, with the cap in a first, second and third position respectively; and

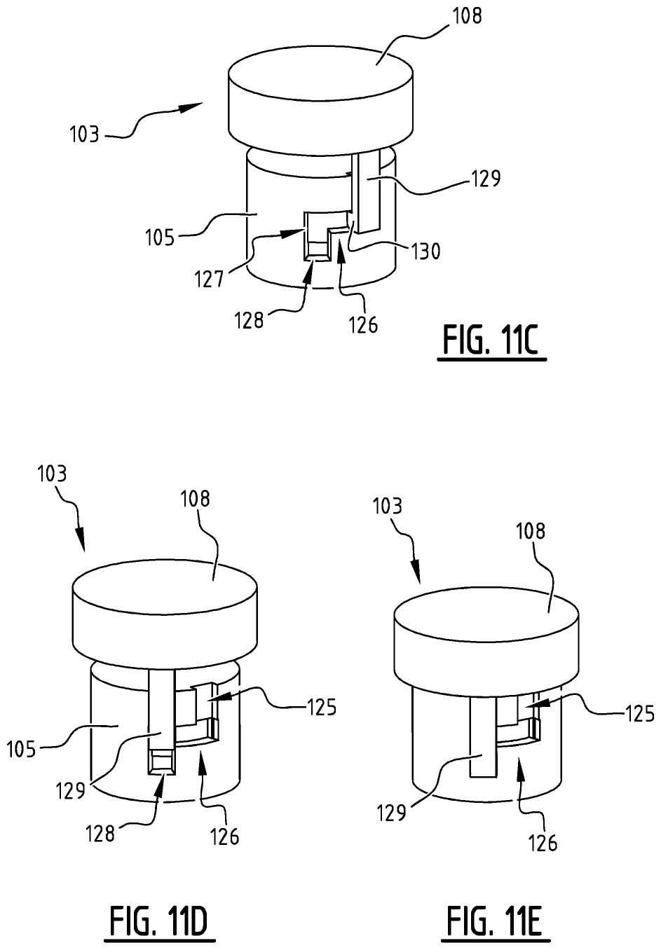

FIGS. 11A-11E schematically show a simplified cross section and simplified perspective views of another embodiment of an assembly of a cap and a microfluidic device, in which the cap has been drawn in different positions.

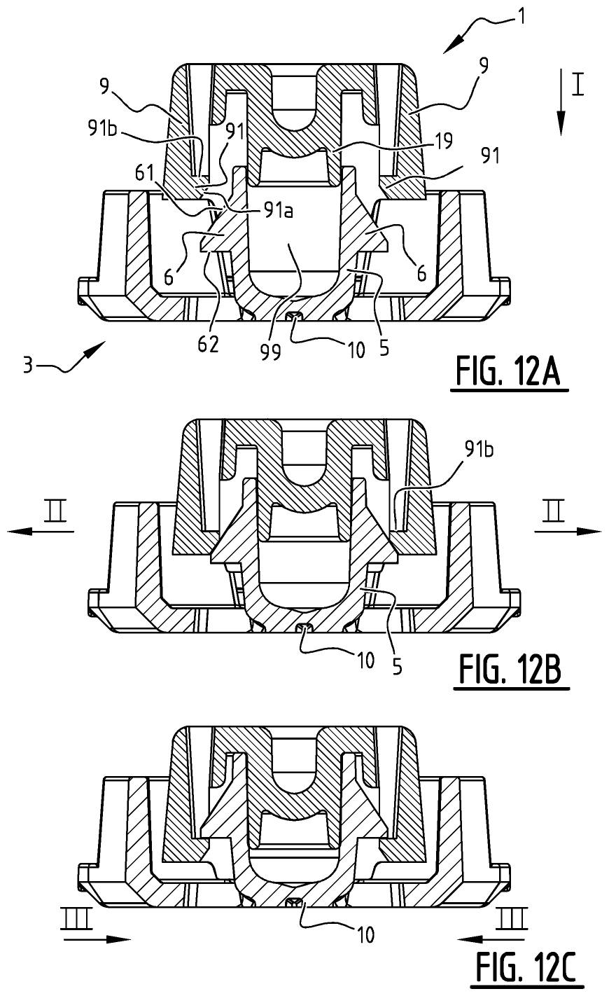

FIGS. 12A-C schematically shows cross sections of the cap and the reservoir in various steps of coupling the cap to a microfluidic device.

Throughout the figures, like elements will be referred to using like reference numerals. Like elements across different embodiments are referred to using reference numerals increased by one hundred (100).

FIGS. 1A and 1B show an assembly 1 of a microfluidic device 2 and a cap 3. The microfluidic device includes an inlet (not visible in FIGS. 1A and 1B) within reservoir 99 and a vent 11 (indicated in FIG. 2 and further). A microfluidic circuit extends between the inlet 10 and the vent 11, and will be described below in more detail with reference to the following figures. The microfluidic device in FIGS. 1A and 1B has, as an example, six different fluid chambers 50. Further, an overflow reservoir 51 is visible. Further details of the cap 3 will also be described further below.

FIG. 2 shows the microfluidic device 202 has a microfluidic circuit connecting the inlet 210 and the vent 211. From the inlet 210 a main fluid channel 252 extends downstream, and finally ends in an overflow reservoir 253, which is connected to the vent 211 via a return line 215. The microfluidic circuit comprises three fluid chamber configurations 254. Each fluid chamber configuration 254 comprises two fluid chambers 255. Details of the fluid chamber configurations 254 are provided only once with reference signs for the sake of clarity. Each fluid chamber 255 is provided with a fluid chamber inlet channel 256 coupling the main fluid channel 252 to an inlet 257 of the fluid chamber 255, and a fluid chamber outlet channel 258 coupled to an outlet 259 of the fluid chamber 255. A pressure stop valve 260 is arranged in the main fluid channel 252 downstream of the coupling with the fluid chamber inlet channel 256. The fluid chamber outlet channel 258 returns to the main fluid channel 252 downstream of said pressure stop valve 260. The pressure stop valve 260 is arranged to block fluid at a pressure below a first burst pressure. The fluid chamber configuration 254 further includes a flow restrictor 261 arranged in the fluid chamber outlet channel 258. The flow restrictor 261 is arranged to provide a back pressure which is higher than the first burst pressure of the pressure stop valve.

The pressure stop valve 260 shown is a capillary stop valve, but other types of pressure stop valves could be used as an alternative. The flow restrictor 261 comprises a capillary stop valve, but another type of flow restrictor could be used, as will be demonstrated below. The capillary stop valve 261 has a second burst pressure higher than the first burst pressure of the pressure stop valve 260 in the main fluid channel 252. The flow restrictor 261 extends in the fluid chamber outlet channel 258 at a distance from both the main fluid channel 252 and the fluid chamber 255.

When fluid is supplied the inlet 210, it will travel down the main fluid channel 252 until it reaches the pressure stop valve 260. Then, the pressure stop valve 260 will prevent the fluid form continuing in the main fluid channel 260, thereby forcing it to flow into the fluid chamber inlet channel 256, ultimately filling the fluid chamber 255 before reaching the flow restrictor 261. When the pressure on the fluid is increased to beyond the first burst pressure, the pressure stop valve 260 will burst and allow fluid to travel in the main fluid channel 252 again. When the fluid reaches the coupling with the fluid chamber outlet channel 258, fluid already in the fluid chamber outlet channel 258 coming from the fluid chamber 255 is prevented at least almost entirely from exiting the fluid chamber 255 and/or the fluid chamber outlet channel 258 by the flow restrictor. As a result, the fluid chamber 255 remains filled, and flow therein is stopped.

The shown fluid chamber configurations 254 have two opposing fluid chambers 255 with their respective inlet and outlet channels 256, 258, both using the same pressure stop valve 260 in the main fluid channel 252. The fluid chamber inlet and outlet channels 256, 258 couple to the main fluid channel 252 at the same longitudinal position thereof. One of the fluid chamber inlet channels 256 could be provided with a pressure stop valve, such as a capillary stop valve, which has a third burst pressure which is lower than the first burst pressure of the pressure stop valve 260 in the main fluid channel 252. Using said pressure stop valve in the fluid chamber inlet channel 256 a filling order for the two fluid chamber 255 can be achieved.

It is noted only one fluid chamber 255 could be provided per fluid chamber configuration 254. In this example, multiple fluid chamber configurations 254 are shown, although only a single fluid chamber configuration 254 could suffice.

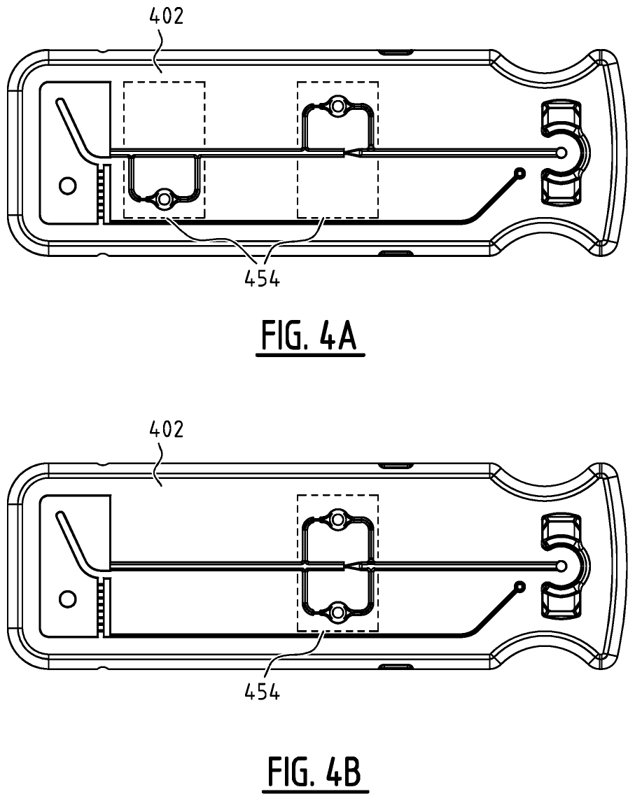

As an example, reference is made to FIGS. 3-5, wherein FIG. 3 shows an embodiment with only a single fluid chamber configuration 354. In case multiple fluid chamber configurations 254, 454 are provided, they may be provided at the same or different longitudinal positions along the main fluid channel 252, 452. It is also possible (FIG. 4B) to provide a single fluid chamber configuration 454 with multiple fluid chambers 455.

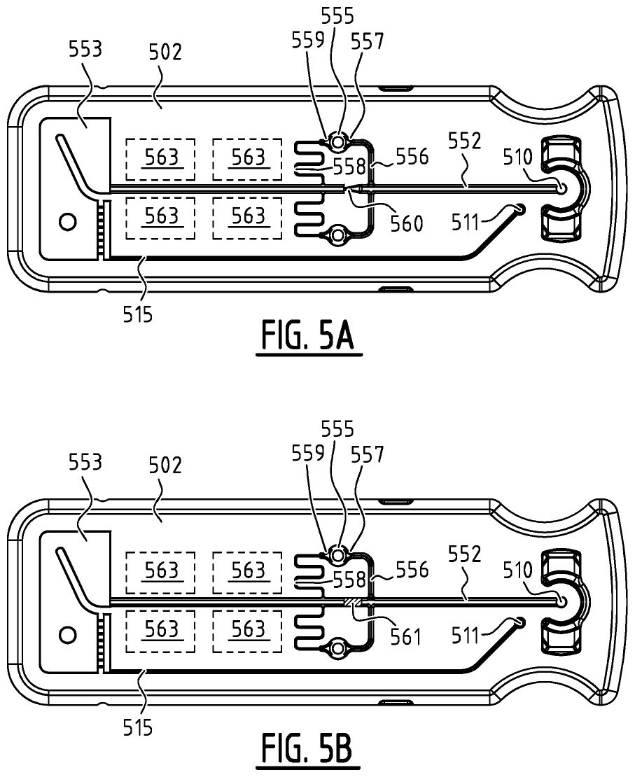

FIG. 5A shows an embodiment of a microfluidic device 502 similar to the embodiments of FIGS. 2-4, which differs in that the flow restrictor is formed by a long and narrow channel 558, which is the fluid chamber outlet channel 558. Due to the channel 558 being sufficiently narrow, flow through the channel is hindered and slowed down, so that sufficient pressure may be built up in order to overcome the first burst pressure of the pressure stop valve 560 in the main fluid channel 552. This type of flow restrictor 558 can be applied to the earlier embodiments, as shown by placeholders 563 indicating the optional presence of further fluid chamber configurations 554. Moreover, one or more fluid chambers 555 could be used for each fluid chamber configuration 554.

FIG. 5B illustrates that instead of a pressure stop valve 560 in the main channel 552, also a flow restrictor can be used in the main channel 552. In this example, the main channel 552 comprises a delay valve 561 downstream of the debranching of the chamber inlet channel 556. The valve 561, as the pressure stop valve 560, will cause the liquid to flow to the chamber inlet channel 556 and thus to the chamber 555.

In this example, the delay valve 561 comprises a liquid soluble material. This will delay the liquid flow through the main channel 552 further downstream, preferably until the chamber 555 is filled. When the valve 561 has opened, in this example when sufficient material has dissolved, the flow resistance through the valve 561 in the main channel 552 is lower than a flow resistance through the then filled chamber 555. Liquid will then (predominantly) flow through the main channel 552. It will be appreciated that also in the configurations with the flow restrictor in the form of a capillary stop valve (see FIGS. 2-4), a delay valve may be used.

Generally, a flow restrictor 560, 561 in the main channel 552 is movable from a first position, wherein the flow resistance through the main channel 552 and valve is higher than a flow resistance to the chamber 555, and a second position, wherein the flow resistance through the channel 552 and valve is lower than the flow resistance to the chamber 555. The first position, for instance the closed position of the pressure burst valve 560, liquid will flow to the chamber 555 and fill it, while (substantially) no liquid will flow through the valve 560. In the second position, for instance when the pressure burst valve 560 has opened, liquid will flow through the valve 560 instead of through the chamber 555. In the example of the pressure burst valve 560, the valve 560 moves from the first (closed) position to the second (open) position under the influence of pressure. In the example of a delay valve, the valve moves from the first to the second position after a predetermined time, for instance due to exposure to liquid. Generally, it is preferred that the valve moves from the first to the second position after the chamber 555 has filled.

Referring to FIG. 6 and further, the details of the assembly and the cap will be described. For the sake of simplicity, the microfluidic device in these figures is shown in a simplified version with respect to that of the earlier figures. However, it is noted that any of the embodiments of FIGS. 1-5 could be used in the assembly of the following figures, or in combination with a cap described in relation to these figures.

FIGS. 6A and 6B show an assembly 1 comprising a microfluidic device 2 and a cap 3. The microfluidic device 2 comprises a body 4 which defines a microfluidic circuit. The microfluidic circuit is not visible in FIGS. 6A and 6B. The cap 3 can be applied to the microfluidic device 2 in order to seal it. The cap 3 is therefore placed over an upstanding edge 5 extending upwards from the body 4 of the microfluidic device 2. The upstanding edge 5 defines a reservoir 99, in which a fluid, for instance a liquid can be received. Snap hooks 6 are provided on two opposing sides of the upstanding edge 5. When the cap 3 is applied, the cap 3 extends over the snap hooks 6 and engages them. The snap hooks 6 accordingly allow the cap 3 to be applied to the microfluidic device 2, but not removed without significant effort and/or the use of tools. As will be explained in further detail below, the snap hooks 6 may also function to provide a stepwise coupling of the cap 3 to the microfluidic device 1 by defining an intermediate position while connecting. Further, two guide plates 7 extend upwards from the body 4 near the upstanding edge 5. The guide plates 7 are configured to engage the cap 3 in order to guide it towards a sealing position shown in FIG. 6B. the guide plates have a slanted surface 7′ which direct the cap 3 to the sealing position. cap 3 has an end surface 8, which forms the top of the cap 3, and a circumferential wall 9. More details of the cap 3 will be described below.

Referring now to FIGS. 7A-7C, more details of the microfluidic device 2 are described. The body 4 defines a microfluidic circuit, which in this example comprises an inlet 10, channels 12, a reaction chamber 13, an overflow, a return channel 15 and a vent 11. The reaction chamber 13 constitutes a functional element, which may be used for instance to perform an assay. A sample can be introduced in the reaction chamber 13 via a channel 12 which is fed via the inlet 10. Another channel 12 downstream of the channel allows superfluous sample material to flow towards the overflow 14. The overflow 14 is connected to the vent 11 via a return channel 12. The vent 11 allows air in the microfluidic circuit, e.g. in the channels 12, the reaction chamber 13, the overflow 14 and the return channel 15 to escape when sample material is introduced via the inlet 10. The channels 12, reaction chamber 13, overflow 14 and return channel 15 are composed of recesses produced in the body 4 of the microfluidic device 2. Suitable techniques for creating such structures are e.g. etching and casting, but other techniques may be employed. In practice, a sealing layer may be applied on the bottom 17 of the body 4 in order to close the recesses, thereby closing the channels 12, the reaction chamber 13, the overflow 14 and the return channel 15. As such, the only way in and out of the microfluidic circuit is via the inlet 10 and vent 11 respectively. In order to show details of the microfluidic circuit, no such sealing layer has been shown in the figures. The inlet 10 and the vent 11 are constituted by bores extending from the top surface 16 to the bottom 17 of the body 4. The bores for the inlet 10 and the vent 11 are placed such that they connect fluidically to the microfluidic circuit. The sealing layer seals one end of the bores, at the bottom 17 of the body 4. The other end of the bores is open at the top surface 16 of the body 4, so that fluid may be let in at the inlet 10, and air may be vented at the vent 11. The circuit may comprise a circuit provided with the pressure stop valves as explained above.

Referring to FIGS. 8A-8C, more details of the cap 3 are described. The cap 3 comprises, at a free end of its circumferential wall 9 a protrusion 18. The protrusion 18 protrudes from the free end in a direction away from the end surface 8 of the cap 3. It is noted that this position of the protrusion 18 is preferred, but can be chosen differently if desired. The protrusion 18 is arranged on a thicker portion 22 of the circumferential wall 9. The thicker portion 22 creates an engagement for the guides 7, and allows sufficient space for the protrusion 18. The circumferential wall 9 has a height h defined from the end surface 8 to the free end of the circumferential wall 9. The height h is maximal at the thicker portion 22, i.e. close to the protrusion 18. At that point, the circumferential wall 9 has a maximum height hₘ. The cap 3 further comprises a pumping mechanism, which in this example comprises an internal rim 19, which in this example is arranged generally concentrically with the circumferential wall 9. The internal rim 19 extends from the end surface, substantially in the same direction as the circumferential wall 9. The pumping mechanism further comprises a web 20 spanning the internal rim 20, which is arranged at a distance d1 from the end surface 8 and at a distance d2 form a free end of the internal rim 19. The web 20 has a convex shape as seen from the free end of the internal rim 19. The end surface 8 defines a blind hole 21 in a central area thereof, the blind hole 21 ending in the web 20. Side walls of the blind hole 21 form a part of the internal rim 19.

With reference to FIGS. 9A and 9B the interaction between the microfluidic device 2 and the cap 3 is described in more detail. In FIG. 4, it can be seen how a size s of an interspace 23 between the internal rim 19 and the circumferential wall 9 decreases towards the end surface 8 of the cap 3. The size s is made to decrease by the external diameter D of the internal rim increasing towards the end surface 8. The internal rim 8 engages the upstanding edge 5, and creates a sealing connection against it. Accordingly, the reservoir 99 defined by the upstanding edge 5 is sealed, thereby sealing the inlet 10. The upstanding edge 5 has a thickness t which decreases in a direction away from the inlet 10.

With reference to FIGS. 10A-10C the pumping action of the cap 3 will be described in more detail. As shown in FIG. 10A, the cap 3 can be brought in a first position in which it leaves free the inlet 10 and the vent 11. Accordingly, both ends of the microfluidic circuit are open. A sample material 24, in this example a liquid, for instance saliva, blood, or another fluid, is provided in the reservoir 99. The cap 3 is brought to a second position shown in FIG. 10B, in which it seals the reservoir 99 but not the vent 11. By sealing the reservoir 99, the inlet 10 is sealed from the exterior of the microfluidic device. The cap 3 and microfluidic device 2 together enclose a volume in the reservoir, which holds the sample material 24. Then, by moving the cap 3 further down, i.e. towards the third position in FIG. 10C, the enclosed volume is decreased. The internal rim 19 remains sealed against the upstanding edge 5, so that the enclosed volume remains sealed. Accordingly, the pressure inside the reservoir 99 is increased, causing the sample material 24 to be pumped into the microfluidic circuit. As can be seen in FIG. 10C, the cap 3 still seals the reservoir 99 and thus the inlet. the situation in FIG. 10C corresponds to that in FIG. 9B, in which it can be seen that the cap 3 also seals the vent, by having forced the protrusion 18 into the vent 11. In the assembly 1 shown, the protrusion 18 has an external diameter which is larger than an internal diameter of the vent 11. Thus, the situation in FIG. 9B reflects a deformation of the protrusion 18 and the vent 11. Similarly, the internal rim 19 and the upstanding edge 5 are slightly deformed, in order to seal against each other in the second and third positions of FIGS. 10B and 10C.

FIGS. 11A-11D show another embodiment of an assembly with a cap 103 and a microfluidic device. FIGS. 11A-11D have been simplified to more clearly explain their differences with respect to the earlier described embodiment. In FIG. 11A the cap 103 can be seen in cross section, in a position in which it seals the inlet 110 of a microfluidic device (partly shown). The body 104 of the microfluidic device is shown in dashed lines. The body 104 and thus the microfluidic circuit may be laid out for instance as described in relation to the embodiment of FIGS. 6A-10C. The cap 103 has an end surface 108 and a circumferential wall 109, as well as an internal rim 119. The web 120 spanning the internal rim 119 is in this embodiment arranged relatively close to the end surface 108 of the cap 103. Further, a protrusion 118 is shown for sealing the vent 118 in the body 104. Unique to this embodiment are snap hooks 129 arranged on the cap, which comprise at their end followers 130. In FIGS. 11B-11D, the circumferential wall 109 is not shown in order to expose the snap hooks 129. The body 104 of the microfluidic device is also not shown. The followers 130 are configured to cooperate with respective slots provided in the upstanding edge 105 of the microfluidic device. The slots each comprise, in this embodiment as an example, three sections 125, 126, 127. The slot acts as a guide for the followers 130. The first section 125 of the slot extends substantially parallel to an axial direction of the cap 103, i.e. vertically. This allows moving the cap 103 from a position away from the microfluidic device, shown in FIG. 11B (e.g. a first position) down towards the microfluidic device. When the internal rim 119 first engages the upstanding edge 105, the reservoir 199 defined between the cap 103 and the microfluidic device is sealed (e.g. a second position). As described above, a pumping action starts from this position onwards, as the cap 103 is moved further towards the microfluidic device. A second section 126 of the slot 126 extends in the circumferential direction of the cap 103, i.e. at an angle with respect to the first section 125. As a result, when moving the cap 103 along the slot (FIG. 11C), the followers 130 are blocked when they reach the second section 126. The second section 126 has a depth which is larger than that of the first section 125. Accordingly, the followers 130 snap into the second section 126, thereby creating a haptic and audible feedback for a user. The feedback may be used to indicate the cap 103 is at an intermediate position, which indicates for the user e.g. a waiting period. Next, the cap 103 can be rotated with respect to the upstanding edge 105, so that the followers 130 move along the second section 126 of the slot. At the end of the second section 126, a third section 127 extends further towards the body 104 of the microfluidic device. This, when reaching the end of the second section 126 (FIG. 11D), the cap 103 can be moved further towards a sealing position, in which both the inlet 110 and the vent 111 are sealed (FIG. 11E), for instance corresponding to the third position described above. The third section 127 has a portion 128 of an even greater depth, so that the followers again snap into place. The depth and shape of the portion 128 in the third section 127 are shaped so that without the application of excessive and/or destructive force, the cap 103 can not be removed from the microfluidic device. Because the reservoir 199 is sealed by the internal rim 119 even before the second section 126 is reached by the followers 130, there is a pumping action before, but also after said moment. Thus, the assembly of FIGS. 11A-11E may be used to create a two-step pumping process.

In FIGS. 12A-C, a cap 3 is shown which cooperates with the snap hooks 6 to provide a two-step pumping process. Also here, when the internal rim 19 first engages the upstanding edge 5, the reservoir 99 defined between the cap 1 and the microfluidic device 3 is sealed (e.g. a second position). Moving the cap 1 further towards the microfluidic device 3 starts the pumping action wherein liquid from the reservoir 99 is pumped into the inlet 10.

The cap 1 is moved downwardly (indicated with arrow I) substantially unrestricted until a guiding surface 91a of the cap 1 abuts a corresponding guiding surface 61 of the microfluidic device 1. This intermediate position is shown in FIG. 12B. In this example, the guiding surface 91a is formed on snap hooks 91 which are arranged on the circumferential wall 9 of the cap 1. The hooks 91 are in this example provided at the lower edge of the circumferential wall 9 of the cap 1 and extend radially inwardly.

The guiding surface 91a of the microfluidic device 3 is provided on snap hooks 6 of the upstanding edge 5 defining the reservoir 9. At least one of the guiding surfaces 61, 91a is a slanted surface, i.e. having a normal with a vertical component next to horizontal component. Thus, when the guiding surfaces 61, 91a engage, the vertical movement I of the cap 1 towards the microfluidic device 3 is restricted. This provides a pause, e.g. an intermediate position, in the pumping process. This pause ensures that there is sufficient time for the liquid to fill the complete microfluidic circuit, for instance a microfluidic circuit comprising a plurality of chambers interconnected by a plurality of pressure valves as described above.

At least one of snap hooks 6, 91, in this example the hooks 91 on the circumferential wall 9 are formed movable, such that upon further movement of the cap 1 towards the microfluidic device 3, the hooks 91 move radially outwardly, as indicated with arrows II in FIG. 12B. As mentioned, the resilient movement of the hooks 91 will result in a resistance in the movement of the cap 1 towards to the microfluidic device 3. When the cap 1 is moved further towards the microfluidic device 3 as shown in FIG. 12C, the hooks 91 of the cap 1 will eventually snap behind the hooks 6 of the rim 5. Locking surfaces 62 and 91b hereby engage and prevent that the cap 1 can be released from the microfluidic device 3. The snapping of the hooks 91, indicated with the arrows III in FIG. 12C, create a haptic and audible feedback for a user.

FIG. 13 shows a microfluidic device similar to that presented in FIG. 2. However, as opposed to the device in FIG. 2, the device of FIG. 13 has only one single and shared pressure stop valve 660 in the main fluid channel 652. Several, in this example all, fluid chamber configurations 654 share the same single pressure stop valve 660, which is arranged downstream of all the fluid chamber configurations 654, i.e. further removed from the inlet 610, and closer to the vent 611. Although fluid chamber configurations 654 herein each have two fluid chambers coupled to the main fluid channel 652 at the same location along it, the same embodiment could have only one fluid chamber coupled at each location along the main fluid channel 652. Further, there is a single vent 611, which is used by the fluid chambers and the main fluid channel 652 since they all lead to the return line 615. In this case, the two leftmost fluid chambers on one side of the main fluid channel 654 share a fluid chamber return line 615′ running to the overflow reservoir 653. The rightmost fluid chambers drain separately from the other fluid chambers to the overflow reservoir 653. The main fluid channel 652 also drains to the overflow reservoir 653, which in turn is connected to the vent 611 via the return line 615. Accordingly, the fluid chamber outlet channels which herein form a return line 615′ are coupled to the main fluid channel 652 via the overflow reservoir 653.

Although the invention has been described above with reference to specific examples and embodiments, the scope of this application is not limited thereto. In fact, the scope is also defined by the following claims.

1. A microfluidic device comprising a microfluidic circuit comprising a main fluid channel and an inlet coupled to the main fluid channel for introducing fluid into the microfluidic circuit and at least one fluid chamber configuration, wherein the fluid chamber configuration comprises:
at least one fluid chamber;
a fluid chamber inlet channel coupling the main fluid channel to an inlet of the fluid chamber;
a fluid chamber outlet channel coupled to an outlet of the fluid chamber;
a pressure stop valve arranged in the main fluid channel downstream of the coupling with the fluid chamber inlet channel, wherein the pressure stop valve is arranged to block fluid at a pressure below a first burst pressure; and
a flow restrictor arranged in the fluid chamber outlet channel, wherein the flow restrictor is arranged to provide a back pressure which is higher than the first burst pressure of the pressure stop valve.

2. The microfluidic device according to claim 1, wherein the pressure stop valve comprises a capillary stop valve.

3. The microfluidic device according to claim 1 or 2, wherein the flow restrictor comprises a pressure stop valve.

4. The microfluidic device according to claim 1, wherein the flow restrictor comprises a capillary stop valve having a second burst pressure higher than the first burst pressure of the pressure stop valve in the main fluid channel.

5. The microfluidic device according to claim 1, wherein the fluid chamber outlet channel couples the outlet of the fluid chamber to the main fluid channel at a location downstream of the pressure stop valve.

6. The microfluidic device according to claim 5, wherein the flow restrictor extends in the fluid chamber outlet channel at a distance from the coupling to the main fluid channel; and wherein optionally the flow restrictor extends in the fluid chamber outlet channel at a distance from the outlet of the fluid chamber.

7. (canceled)

8. The microfluidic device according to claim 1, comprising a plurality of fluid chambers coupled to the main fluid channel, wherein each of the chambers is provided with a respective fluid chamber inlet channel and with a respective outlet channel provided with a flow restrictor.

9. The microfluidic device according to claim 8, wherein at least two fluid chambers are arranged at opposite sides of the main fluid channel and are coupled thereto with respective fluid chamber inlet channels.

10. The microfluidic device according to claim 8, comprising at least two such fluid chamber configurations having fluid chamber inlet channels coupled to the main fluid channel at different positions along the main fluid channel, and a single shared pressure stop valve in the main fluid channel for said at least two fluid chamber configurations downstream of the inlet channels of the at least two fluid chamber configurations.

11. The microfluidic device according to claim 5, comprising a plurality of fluid chambers coupled to the main fluid channel, wherein each of the chambers is provided with a respective fluid chamber inlet channel and with a respective outlet channel provided with a flow restrictor, wherein the fluid chamber outlet channels couples the outlet of the fluid chamber to the main fluid channel downstream of the single shared pressure stop valve.

12. The microfluidic device according to, wherein the at least one fluid chamber configuration further comprises:
a second fluid chamber;
a second fluid chamber inlet channel coupling the main fluid channel to an inlet of the second fluid chamber, wherein the pressure stop valve in the main fluid channel is also arranged downstream of the coupling with the second fluid chamber inlet channel;
a second fluid chamber outlet channel coupled to an outlet of the second fluid chamber; and
a second flow restrictor arranged in the second fluid chamber outlet channel, wherein the second flow restrictor is arranged to provide a back pressure which is higher than the first burst pressure of the pressure stop valve in the main fluid channel.

13. The microfluidic device according to claim 12, wherein the second fluid chamber inlet channel comprises a pressure stop valve, preferably a capillary stop valve, having a third burst pressure which is lower than the first burst pressure of the pressure stop valve in the main fluid channel.

14. The microfluidic device according to claim 12, wherein the first and second fluid chamber inlet channels are coupled to the main fluid channel at substantially the same longitudinal location of the main fluid channel, wherein also the first and second fluid chamber outlet channels are coupled to the main fluid channel at substantially the same longitudinal location of the main fluid channel.

15. The microfluidic device according to claim 1, comprising a plurality of fluid chamber configurations coupled to the main fluid channel.

16. The microfluidic device according to claim 15, wherein the plurality of fluid chamber configurations are arranged in series along the main fluid channel, wherein a pressure stop valve of a fluid chamber configuration is arranged upstream of a fluid chamber inlet channel of a subsequent fluid chamber configuration.

17. An assembly of a microfluidic device according to claim 1, and a cap to seal the inlet, wherein the assembly comprises a pumping mechanism, which optionally comprises the cap, wherein the pumping mechanism is arranged to introduce fluid through the inlet into the microfluidic circuit.

18. The assembly according to claim 17, wherein the pumping mechanism is configured to fill at least one, optionally multiple, optionally all, fluid chambers of the microfluidic device, and wherein optionally the pumping mechanism is configured to provide a pressure sufficient to burst the pressure stop valve.

19. (canceled)

20. The assembly according to claim 18, wherein the fluid chamber outlet channel couples the outlet of the fluid chamber to the main fluid channel at a location downstream of the pressure stop valve, and wherein the flow restrictor extends in the fluid chamber outlet channel at a distance from the coupling to the main fluid channel, wherein the microfluidic circuit comprises at least one vent, and wherein the cap is further configured to seal the at least one vent.

21. A method of at least partially filling a fluid chamber in a microfluidic device according to claim 1, the method comprising:
introducing fluid in the main channel through the inlet;
blocking the fluid in the main channel using the pressure stop valve arranged therein;
filling said fluid chamber via its fluid chamber inlet channel;
restricting flow through the outlet channel of said fluid chamber; and
bursting the pressure stop valve in the main fluid channel.

22. The method according to claim 21, wherein introducing the fluid in the main channel comprises:
providing the fluid in or near the inlet of the microfluidic device;
forcing the fluid into the microfluidic circuit of the microfluidic device through the inlet, whilst allowing fluid to vent through a vent of the microfluidic circuit;
sealing the inlet and the vent using a cap;
wherein optionally the step of forcing the fluid into the microfluidic circuit comprises the subsequent steps of:
introducing liquid in the microfluidic circuit for filling at least two fluid chambers; and
introducing a gas in the main channel of the microfluidic circuit for compartmentalizing the at least two liquid filled fluid chambers.

23. (canceled)
